(19) United States
(12) Patent Application Publication
(10) Pub. No.: US 2018/0211183 A1
(43) Pub. Date: Jul. 26, 2018

(54) FACILITATION OF AUGMENTED REALITY SPACES AS A SERVICE

(71) Applicant: AT&T Intellectual Property I, L.P., Atlanta, GA (US)

(72) Inventor: Timothy Innes, Atlanta, GA (US)

(21) Appl. No.: 15/415,212

(22) Filed: Jan. 25, 2017

(51) Int. Cl. G06Q 10/02; G06Q 20/10; G06Q 30/02; H04W 4/02

(52) U.S. Cl. CPC G06Q 10/02; G06Q 20/102; H04W 4/02; G06Q 30/0269; G06Q 30/0267

(57) ABSTRACT

An augmented reality reservation system can facilitate reservation for advertisement space in augment reality. The augmented reality reservation system can comprise a holographic projector, a three-dimensional internal positioning device, an augment reality database and a mobile device. Based on a location of the mobile device, the augmented reality reservation system can display an advertisement to a user of the mobile device. The augmented reality reservation system can also allow a vendor to reserve specific augmented reality spaces via a reservation system.

### TECHNICAL FIELD

This disclosure relates generally to facilitating augmented reality space reservations. More specifically, this disclosure relates to facilitating augmented reality spaces in conjunction with holographic projections.

### BACKGROUND

Augmented reality (AR) is a live direct or indirect view of a physical, real-world environment where elements are augmented (or supplemented) by computer-generated sensory inputs such as: sound, video, graphics, and/or global positioning system (GPS) data. A view of reality can be modified (possibly even diminished rather than augmented) by a computer. As a result, AR technology functions by enhancing a current perception of reality. By contrast, virtual reality can replace the real world with a simulated one. Augmentation is conventionally in real time and in semantic context with environmental elements, such as sports scores on TV during a match. With the help of advanced AR technology (e.g., adding computer vision and object recognition) the information about the surrounding real world of a user can become interactive and digitally manipulatable. Information about the environment and its objects can be overlaid on the real world. This information can be virtual or real. Augmented reality can bring out the components of the digital world into a user's perceived real world experience.

The above-described background relating to augmented reality is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless network comprising an augmented reality space component integration according to one or more embodiments.

FIG. 2 illustrates an example wireless network comprising an augmented reality 3-D positioning unit according to one or more embodiments.

FIG. 3 illustrates an example wireless network comprising a holographic enhancement unit according to one or more embodiments.

FIG. 4 illustrates an example wireless network performing an augmented reality synchronization according to one or more embodiments.

FIG. 5 illustrates an example schematic system block diagram of an augmented reality system according to one or more embodiments.

FIG. 6 illustrates an example schematic system block diagram of an augmented reality system comprising a vendor reservation request according to one or more embodiments.

FIG. 7 illustrates an example schematic system block diagram an augmented reality system comprising an advertiser reservation request according to one or more embodiments.

FIG. 8 illustrates an example schematic system block diagram for an augmented reality system according to one or more embodiments.

FIG. 9 illustrates an example schematic system block diagram an augmented reality system according to one or more embodiments.

FIG. 10 illustrates an example schematic system block diagram for an augmented reality system according to one or more embodiments.

FIG. 11 illustrates an example block diagram of an example mobile handset operable to engage in a system architecture that facilitates secure wireless communication according to one or more embodiments described herein.

FIG. 12 illustrates an example block diagram of an example computer operable to engage in a system architecture that facilitates secure wireless communication according to one or more embodiments described herein.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various machine-readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview, various embodiments are described herein to facilitate an augmented reality reservation system.

For simplicity of explanation, the methods are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereafter are capable of being stored on an article of manufacture (e.g., a machine--readable storage medium) to facilitate transporting and transferring such methodologies to computers. The term article of manufacture, as used herein, is intended to encompass a computer program accessible from any computer-readable device, carrier, or media, including a non-transitory machine-readable storage medium or a machine readable storage medium.

It is noted that although various aspects and embodiments are discussed herein with respect to Universal Mobile Telecommunications System (UMTS) and/or Long Term Evolution (LTE), the disclosed aspects are not limited to a UMTS implementation and/or an LTE implementation. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

Described herein are systems, methods, articles of manufacture, and other embodiments or implementations that can facilitate an augmented reality reservation system. Facilitating an augmented reality reservation system can be implemented in connection with any type of device with a connection to the communications network such as: a mobile handset, a computer, a handheld device, or the like.

An augmented reality space reservation system can demarcate augmented reality spaces on public or private property, where access can be sold to game vendors, advertisers, and/or the general public. City ordinances can manage zoning bylaws for augmented reality spaces on public land (e.g., sell licenses or permits). Augmented reality component integration can integrate with multiple 3rd party vendor games (e.g., Pokemon Go) in an augmented reality space experience. A three-dimensional interior positioning unit can map out an interior building space in three dimensions, allowing for augmented reality experiences that can move from level-to-level, floor-to-floor, etc. A holographic enhancement unit can enrich the augmented reality experience with holographic projections. Rental fees can be charged for use of the augmented reality space by augmented reality game vendors, and players can also be charged an entrance fee to an augmented reality space. Additionally, advertising space can be sold to companies. Advertisers can be sold integrated game templates where they can embed their signage and/or advertisements into the game and/or offer promotional offers as a prize for completing the game. Augmented reality spaces can also be sold as a service platform to businesses that wish to run an augmented reality space at their location, such as in the real estate industry.

An augmented reality (AR) application can be a mobile application that projects computer images onto a live video stream of a user's current environment. It can differ from the immersive experience of virtual reality, where the user is removed from their real world setting and placed in a completely artificial computer generated world. Yet, both virtual and augmented reality applications can share similar features and technologies. Augmented reality applications currently use global positioning system (GPS) waypoints to trigger computer generated image projections, however indoor location specific images cannot be triggered. For example, a corporate real estate firm could use a building with 44 floors to host an augmented reality application, and on each floor, they could host a different experience. GPS is not sufficient for indoor location plotting because it does not include a coordinate for elevation.

3^{rd} party application vendors and advertisers who register with the AR space can have their offerings integrated into a rich interactive experience. There are several ways to monetize the AR spaces as a service platform, such as: charging entrance fees to AR spaces, renting AR space slots to application vendors, and/or renting AR space slots to advertisers. Additionally, internet service providers can sell the AR space as a service platform as a bundled feature. The AR spaces as a service platform can comprise the following technologies: reservation system, 3-D location plotting, a holographic enhancement unit etc. A single AR space can host multiple AR applications and advertising materials concurrently. Venders can request reservations through the AR spaces as a service platform. Advertisers can have various options including, but not limited to: 1) simply loading promotional materials, such as signage or coupons, which can then be positioned on the AR space user interface; 2) they can have their promotional materials featured in an AR video game; 3) the AR space can come pre-loaded with basic AR games—similar to how a personal computer comes preloaded with some basic video games (e.g., solitaire); and/or 3) the AR spaces as a service platform can provide the option to embed advertiser's promotional material into stock games and can set a special deal or coupon offer as the prize for winning.

Advertisers can invest or sponsor 3rd party vendors to create AR games for them. Advertisers can then request an AR space reservation slot for a specific time, duration, date, etc. Mapping, in three dimensions, of the location of AR spaces can be viewed on a mobile device, which is relevant when several AR spaces exist inside a building but are positioned on different levels. To accomplish this, the AR space can be equipped with beacon devices that broadcast location information via Wi-Fi. The AR spaces as a service platform can translate the beacon device signals into a multi-level map viewable on the user's mobile device. The augmented reality applications can also incorporate three dimensional holographic projections (from a holographic projector) into the interactive experience, whereby computer generated images can be projected onto a live stream video and/or images of the local environment. Users can also use their mobile devices to interact with the holograms. The AR spaces as a service platform can provide the interface between the 3rd party vendor's augmented reality application and the projected hologram. This interface can bring reactive motion and behavior directions to the hologram based on the user's input and augmented reality application rules.

It should also be noted that an artificial intelligence (AI) component can facilitate automating one or more features in accordance with the disclosed aspects. A memory and a processor as well as other components can include functionality with regard to the figures. The disclosed aspects in connection with facilitating AR spaces as a service can employ various AI-based schemes for carrying out various aspects thereof. For example, a process for detecting one or more trigger events, reserving an AR space, and modifying one or more reported measurements, and so forth, can be facilitated with an example automatic classifier system and process.

An example classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that can be automatically performed.

A support vector machine (SVM) is an example of a classifier that can be employed. The SVM can operate by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also may be inclusive of statistical regression that is utilized to develop models of priority.

The disclosed aspects can employ classifiers that are explicitly trained (e.g., via a generic training data) as well as implicitly trained (e.g., via observing mobile device usage as it relates to triggering events, observing network frequency/technology, receiving extrinsic information, and so on). For example, SVMs can be configured via a learning or training phase within a classifier constructor and feature selection module. Thus, the classifier(s) can be used to automatically learn and perform a number of functions, including but not limited to reserving AR spaces, releasing AR spaces, and so forth. The criteria can include, but is not limited to, predefined values, frequency attenuation tables or other parameters, service provider preferences and/or policies, and so on.

In one embodiment, described herein is a method comprising demarcating a physical location for an augmented reality function; and receiving request data indicative of a request to reserve the physical location from a mobile device. Furthermore, in response to the receiving the request data and based on a condition associated with the augmented reality function being determined to have been satisfied, the method can comprise allocating the physical location for usage according to the augmented reality function. Hence, based on the allocating, the method can comprise receiving service data representative of a service related to the augmented reality function.

According to another embodiment, a system can facilitate, mapping three dimensional location data representative of a three dimensional space to a physical location, resulting in mapped location data, and receiving request data associated with a request to assign the mapped location data to a user identity. In response to receiving the request data, the system can facilitate allocating the mapped location data to the user identity, resulting in location allocation data that identifies the user identity as having an access privilege with respect to the mapped location data. Consequently, the system can facilitate facilitating an augmented reality service at the physical location according to the three dimensional space.

According to yet another embodiment, described herein is a machine-readable storage medium that can perform the operations comprising receiving a request for an augmented reality location associated with a physical location. In response to receiving the request, the machine-readable storage medium can perform operations comprising analyzing payment data representative of a payment from a mobile device. In response to a condition associated with the payment data being determined to have been satisfied, the operations can comprise reserving the augmented reality location for a user identity associated with the mobile device; and based on the reserving, the operations can comprise facilitating displaying an augmented reality projection associated with the request for the user identity.

These and other embodiments or implementations are described in more detail below with reference to the drawings.

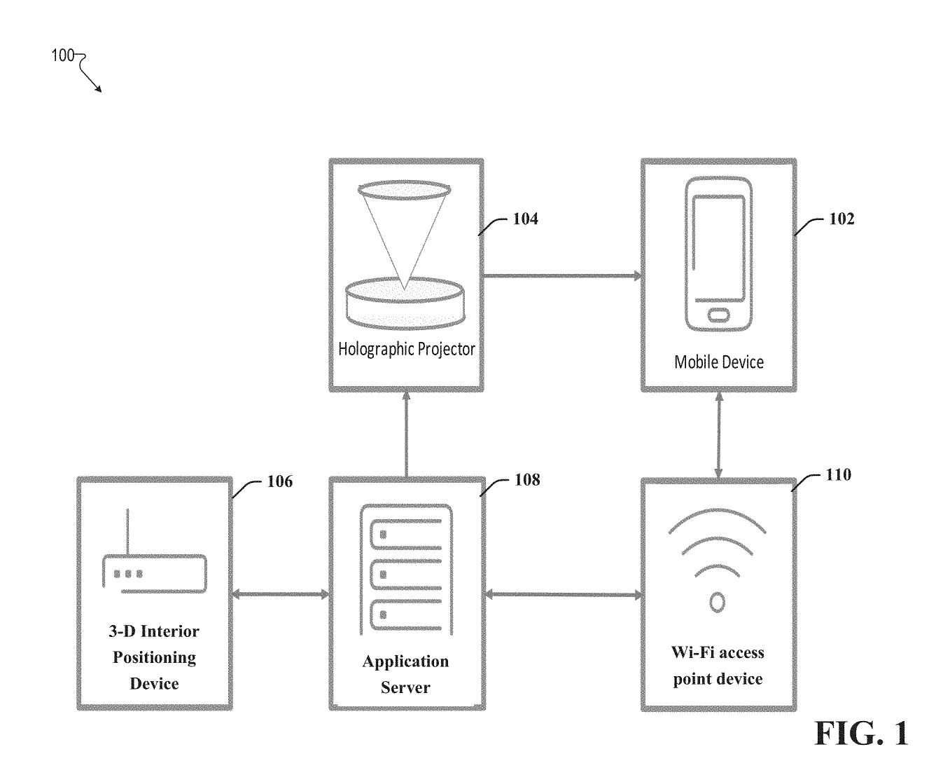

Referring now to FIG. 1, illustrated is an example wireless network comprising an augmented reality space component integration according to one or more embodiments. AR system 100 can comprise several components including: a mobile device 102, a holographic projector 104, a 3-D interior positioning device 106, an application server 108, and a Wi-Fi access point device 110. The mobile device 102 can communicate with the Wi-Fi access point device 110 and the holographic projector 104. The application server 108 can communicate with the 3-D interior positioning device 106 and store data from the 3-D interior positioning device 106. For example, the 3-D interior positioning device 106 can collect and generate 3-D data associated with an architecture of a building (e.g., a 3-D floor plan). The 3-D interior positioning device 106 can then send the 3-D data to the application server 108 for storing. Based on the 3-D data and data associated with the mobile device 102 (e.g., location, application usage, instructions), the holographic projector 104 can generate and project holograms to a specific location, which can then interact with a user of the mobile device 102.

The AR system 100 can allow persons to reserve and allocate advertisement and gaming space. For example, a system manager can determine if a person has paid to reserve an AR space via a mobile device application. If the person has paid, then the system manager can allocate a specific AR space to the person for a specific window of time. For example, if a soda manufacturing company wants to display an advertisement on the 3^{rd} floor of a corporate building near the cafeteria area at noon, then the soda manufacturer can pay to have its advertisement displayed, via AR, at that specific location and time. Therefore, individuals near the cafeteria can see the advertisement via their mobile device 102. Additionally, individuals can interact with a holographic projection based on the advertisement. The holographic projection could be a representation of a soda manufacturer representative wearing appropriate company apparel with logos. The holographic projection can also interact with the individuals based on a specific need of the individual. The specific need can be determined from predefine and/or pre-captured data. For instance, any individual can have a user profile on their mobile device 102, wherein the user profile can indicate that the individual has a preference for soda. Thus the hologram's interaction with the individual can be more direct rather than if the hologram was interacting passively with an individual who has not indicated a preference for soda. Additionally, the user can be prompted, via their mobile device 102, to see additional information regarding the advertisement, and if the user chooses to do so, then a holographic display can begin interacting with the individual in a more direct manner.

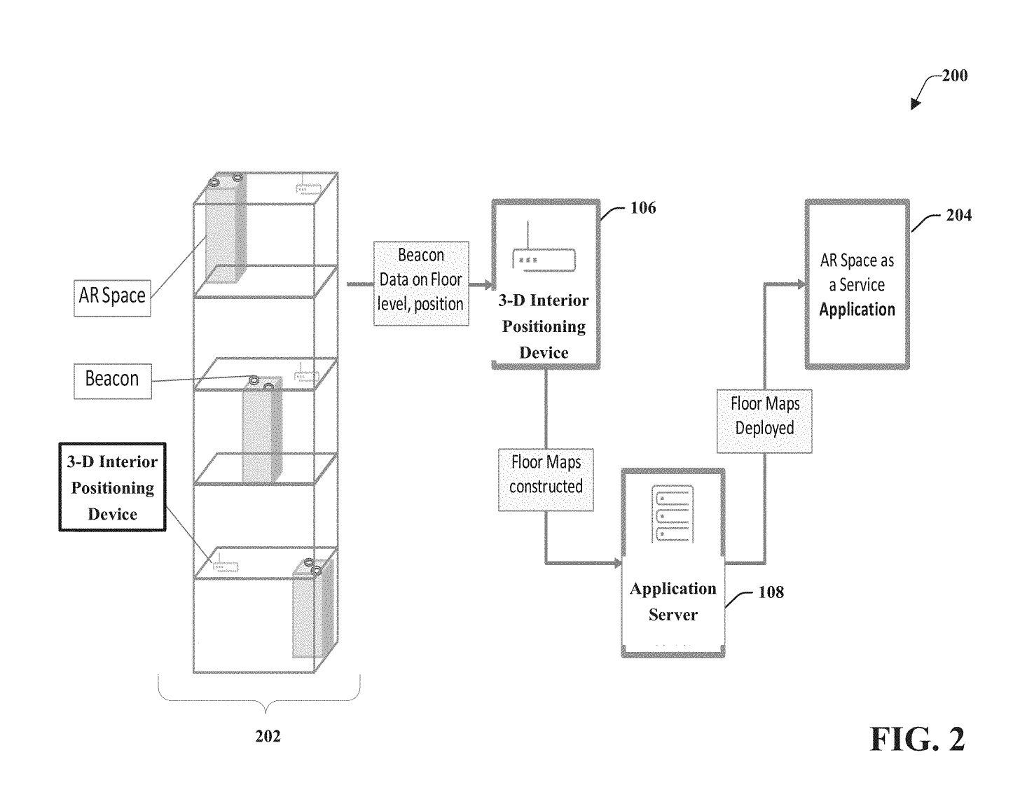

Referring now to FIG. 2, illustrated is an example wireless network comprising an augmented reality 3-D positioning unit according to one or more embodiments. 3-dimensional mappings of the location of AR spaces, which can be viewed on a mobile device, are useful when several AR spaces exist inside a building but are positioned on different levels. The AR space can be equipped with beacon devices that broadcast location information via Wi-Fi. The AR spaces as a service platform can translate beacon device signals into a multilevel map viewable on the user's mobile device 102.

For example, the 3-D interior positioning device 106 can determine a height associated with a given AR space. This can allow for various AR experiences on various floors of a building. Therefore, one AR reality advertisement can be presented at the same longitude and latitude as another AR reality advertisement but at different heights (e.g., the 35^{th} floor and the 36^{th} floor of a building). Since regular GPS coordinates would just overlay both AR advertisements at the same longitude and latitude, causing them to overlap, the 3-D interior positioning device 106 can be used to generate additional AR real estate based on a vertical coordinate system accounting for depth. The AR space application server 108 can store location data generated by beacon devices placed in various locations on various floors of building 202. The beacon device data can be communicated from the beacons to the 3-D interior positioning device 106, which can then construct a floor map and send the floor map data to the AR space application server 108. The AR space application server 108 can then deploy the floor maps for use by an AR space as a service application 204 of the system 200. It should be noted that although a 3-D interior positioning device 106 is discussed for purposes of this disclosure, a 3-D exterior positioning device can be leveraged for outdoor purposes (e.g., generating an AR space in a tree).

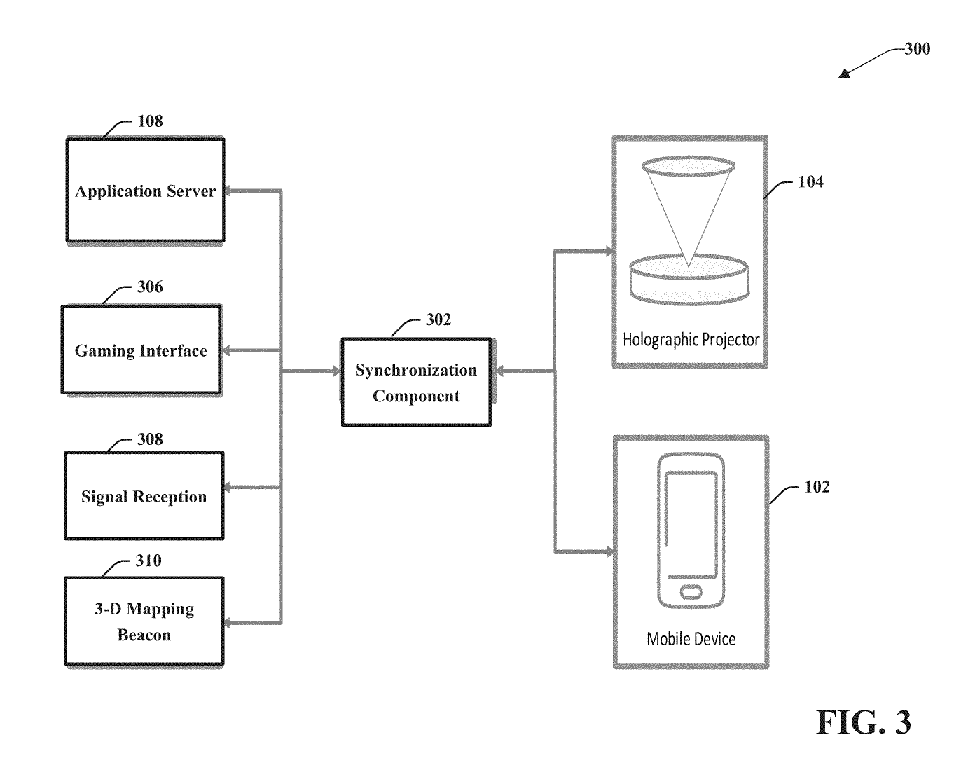

Referring now to FIG. 3, illustrated is an example wireless network comprising a holographic enhancement unit according to one or more embodiments. The system 100 can comprise the holographic system 300 wherein the holographic projector 104 can communicate bi-directionally with the mobile device 102 and a synchronization component 302. The synchronization component 302 can synchronize various inputs and outputs between the holographic projector 104 and other components or devices. For example, an AR space application server 108 can store and generate position data and movement data associated with a holograph of the holographic projector 104. Additionally, a gaming interface 306 can detect attributes (e.g., hit, miss, motion, etc.) associated with a person interacting with a game. The holographic projector 104 can then interact with the person based on attribute data received via the gaming interface 306.

Additionally, Bluetooth or other wireless signal communication can be received by a signal reception component 308. The Bluetooth signal can indicate that a person is within a defined distance of the holographic projector 104 or a holograph. During a game, a player's (e.g., a person's) position can be determined by a 3-D mapping beacon device 310. The position data can be used to generate a reaction from a holograph. For instance, the holograph might only wave to the player if the player is within a defined distance of the holograph and/or the holographic projector 104. It should be noted that the AR space server 108, the gaming interface 306, the signal reception component 308, the 3-D mapping beacon device 310, the synchronization component 302, the holographic projector 104, and the mobile device 102 can all be communicatively coupled and send and receive signal data simultaneously.

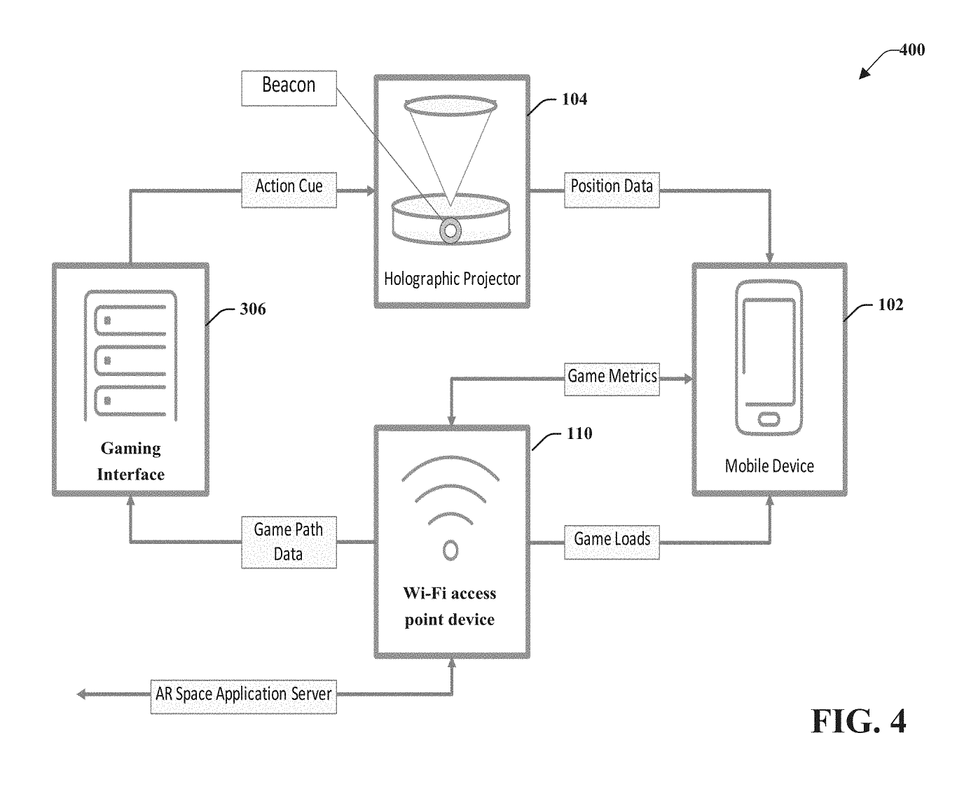

Referring now to FIG. 4, illustrated is an example wireless network performing an augmented reality synchronization according to one or more embodiments. In another embodiment, the holographic projector 104 can comprise a beacon device in a cyclical system 400. When the holographic projector 104 comprises the beacon device, position data can be obtained relative to the location of the holographic projector 104. The position data can then be sent to the mobile device 102 to facilitate a game. For instance, the Wi-Fi access point device 110 can send game data to the mobile device 102 in response to a location associated with the mobile device 102 relative to the holographic projector device 104. Gaming metrics (e.g., score, percentage, accuracy, rounds, statistics, etc.) can then be shared between the Wi-Fi access point device 110 and the mobile device 102. The gaming metrics can then be sent to the gaming interface 306 to provide action data to the holographic projector 104. The holographic projector 104 can then use the action data to generate and position the holograph according to the game.

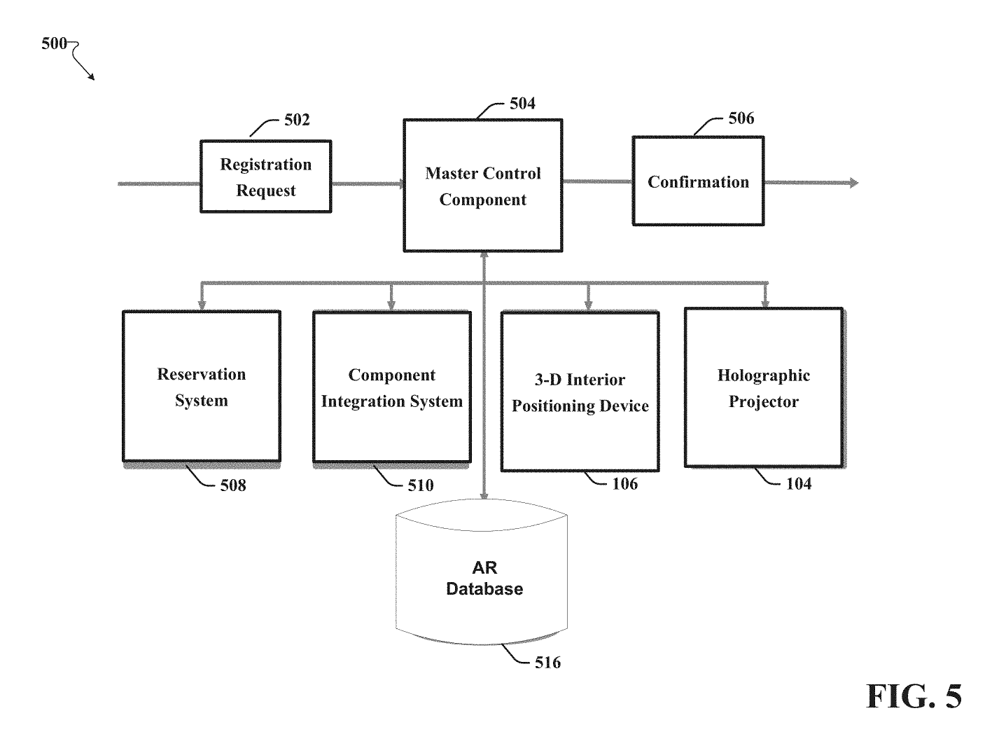

Referring now to FIG. 5, illustrated is an example schematic system block diagram of an augmented reality system according to one or more embodiments. In another embodiment, an AR system 500 can comprise a master controller component 504. The AR system 500 can receive user registration request data, from an application of the mobile device 102, at element 502 and send the confirmation data back to the mobile device at element 506. In response to the request, the master controller 504 can check against an AR database 516 prior to sending confirmation to the mobile device 102. Consequently, a reservation can be made via the reservation system 508. At element 510, a component integration system can integrate (e.g., for gaming) the master controller 504, the AR database 516, the 3-D interior positioning device 106, and the holographic projector 104 to generate bi-direction communication between them all.

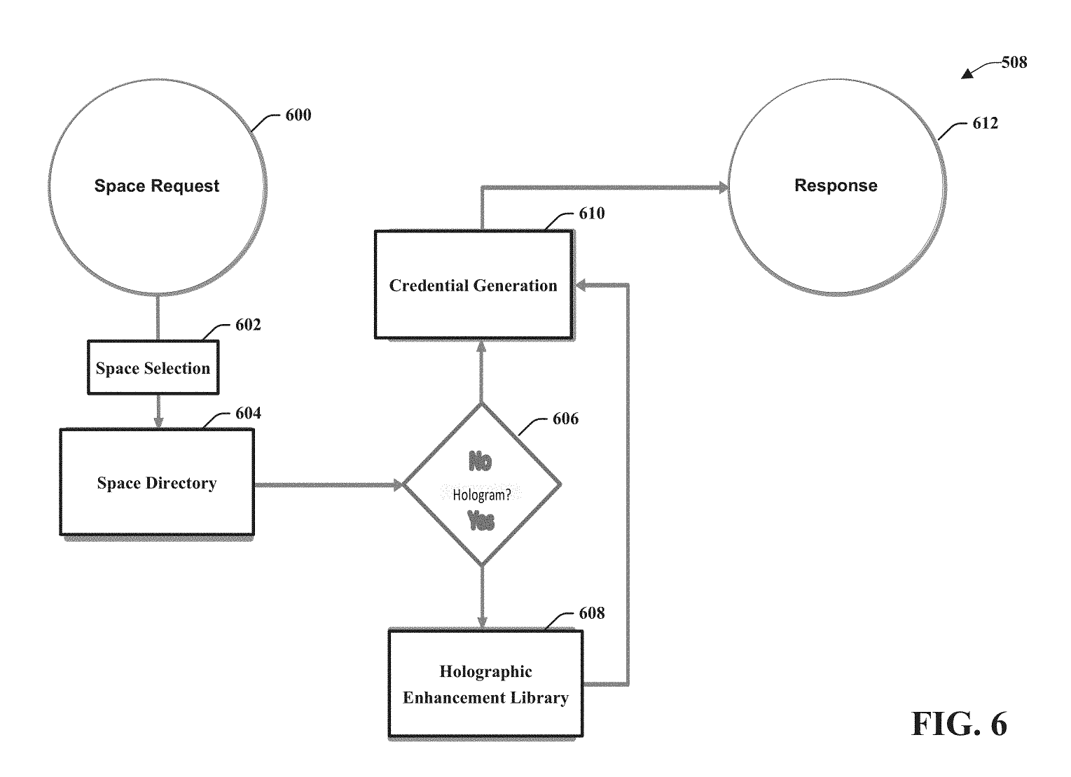

Referring now to FIG. 6, illustrated is an example schematic system block diagram of an augmented reality system comprising a vendor reservation request according to one or more embodiments. The reservation system 508 can be invoked with a request at element 600. The request can comprise a requested AR space selection at element 602. The AR database 516 can be checked at element 604 via a space directory. At element 606, it can be determined as to whether a hologram projection is needed. If a hologram projection is needed, then a holographic enhancement library can be checked. After the holographic enhancement library has been accessed, user credentials can be generated via a credential generation element 608. The credential generation element 608 can generate a user identification, a password, security data, encryption key, etc. Alternatively, if a hologram is not needed at element 606, then the process can proceed directly to credential generation element 608. Thereafter, credentials can be granted and a reservation confirmation response can be sent to the requestor at element 610. The response at element 612 can provide the requestor with the user credentials and access to the space. Thus the user credentials can be used for any follow-up requests at a later time and/or date.

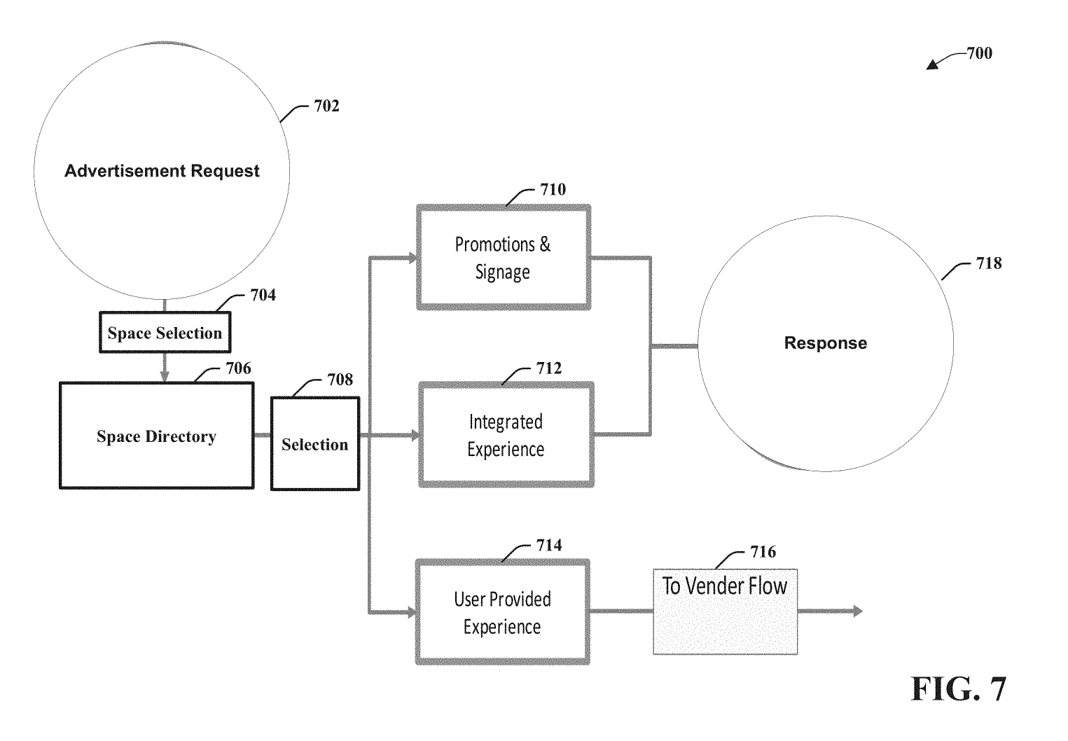

Referring now to FIG. 7, illustrated is an augmented reality system comprising an advertiser reservation request according to one or more embodiments. In an alternative embodiment an advertisement reservation request system 700 can be initiated with an advertisement request at element 702. The request can comprise a requested space selection at element 704. The AR database 516 can be checked at element 706. The advertisement reservation request system 700 can select between several advertisements including, but not limited to promotions and signage at element 710, an integrated experience at element 712, and a user provided experience at element 714. If the user provided experience is selected at element 714, then at element 716, the user provided experience can be handed off to a vendor for facilitation. Conversely, if promotions and signage are selected at element 710 and/or an integrated experience is selected at element 712, the advertisement reservation request system 700 can send a confirmation to the advertisement reservation requestor at element 718.

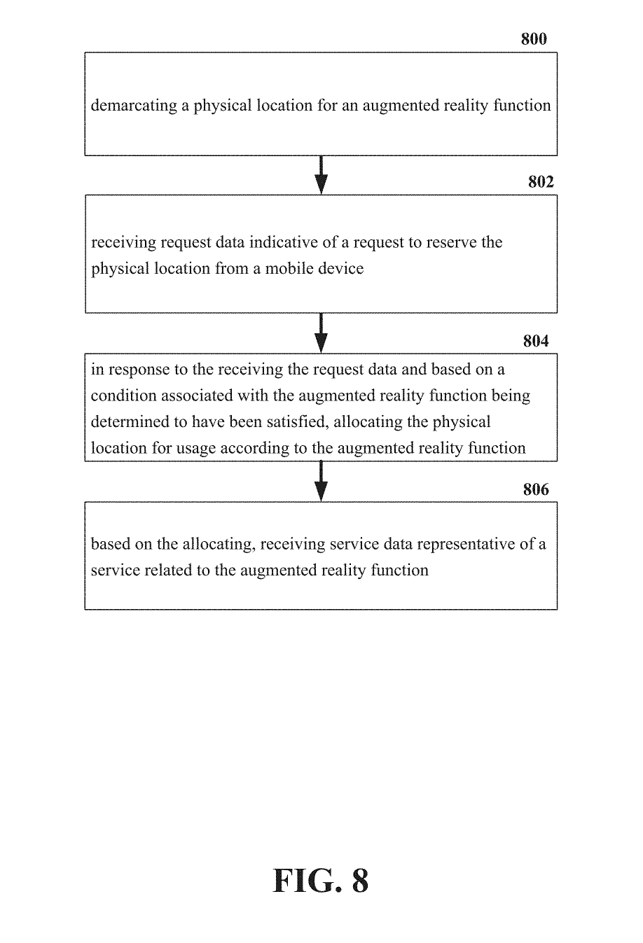

Referring now to FIG. 8, illustrated is an augmented reality system according to one or more embodiments. At element 800 a method can comprise demarcating a physical location for an augmented reality function (e.g., via the 3-D mapping beacon 310). At element 802, the method can comprise receiving request data (e.g., via the master controller 504) indicative of a request to reserve the physical location from a mobile device (e.g., via the mobile device 102). In response to the receiving the request data and based on a condition associated with the augmented reality function being determined to have been satisfied, at element 804 the method can comprise allocating (e.g., via the space selection at 602) the physical location for usage according to the augmented reality function. Consequently, based on the allocating, at element 806 the method can comprise receiving service data representative of a service (e.g., gaming, advertisements, etc.) related to the augmented reality function.

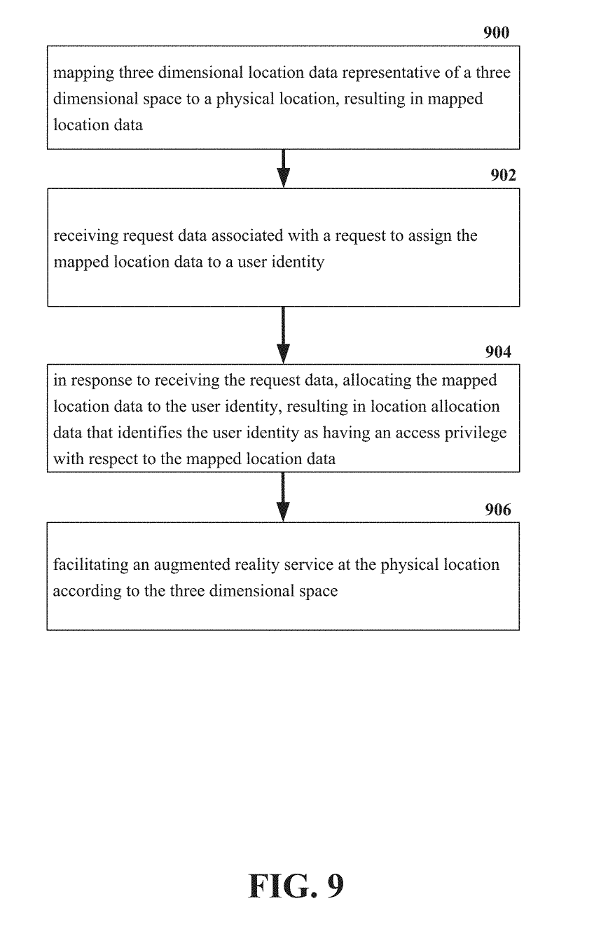

Referring now to FIG. 9, illustrated is an augmented reality system according to one or more embodiments. At element 900 a system can comprise mapping three dimensional location data (e.g., via the 3-D mapping beacon 310) representative of a three dimensional space to a physical location, resulting in mapped location data. At element 902, the system can receive request data (e.g., via the reservation system 508) associated with a request (e.g. at element 600) to assign the mapped location data to a user identity (e.g., the user identity can be associated with the mobile device 102). In response to receiving the request data, at element 904, the system can allocate the mapped location data to the user identity, resulting in location allocation data that identifies the user identity as having an access privilege (e.g., via the credential generation at element 608) with respect to the mapped location data. Thus, the system can facilitate an augmented reality service at the physical location according to the three dimensional space at element 906.

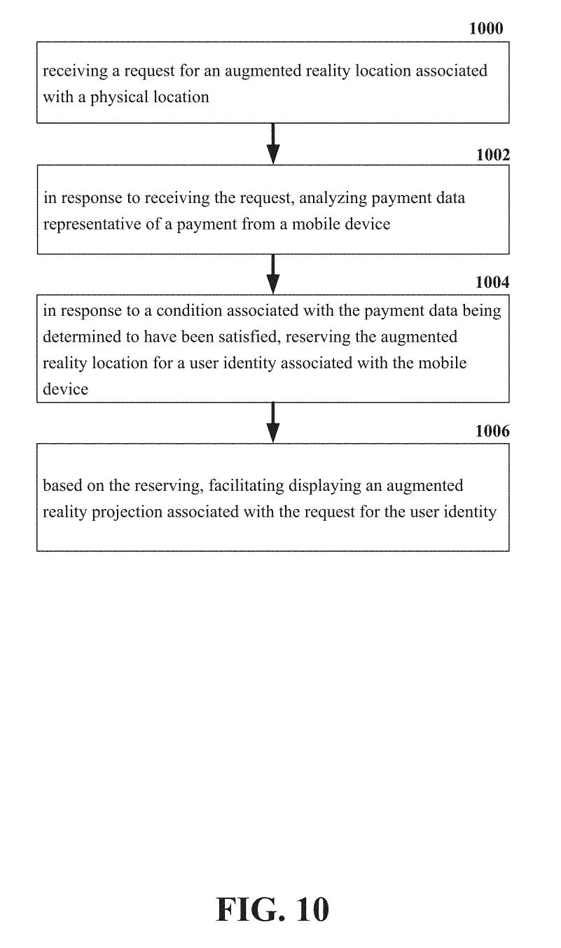

Referring now to FIG. 10, illustrated is an augmented reality system according to one or more embodiments. At element 1000, a machine-readable storage medium can comprise receiving a request (e.g., via the master controller 504) for an augmented reality location associated with a physical location. At element 1002, in response to the receiving the request, the machine-readable storage medium can comprise analyzing payment data representative of a payment from a mobile device (e.g., via the mobile device 102). Furthermore, in response to a condition associated with the payment data being determined to have been satisfied, the machine-readable storage medium can comprise reserving (e.g., via the reservation system 508) the augmented reality location for a user identity associated with the mobile device at element 1004. Additionally, at element 1006, based on the reserving, the machine-readable storage medium can facilitate displaying an augmented reality projection (e.g., via the holographic projector 104) associated with the request for the user identity.

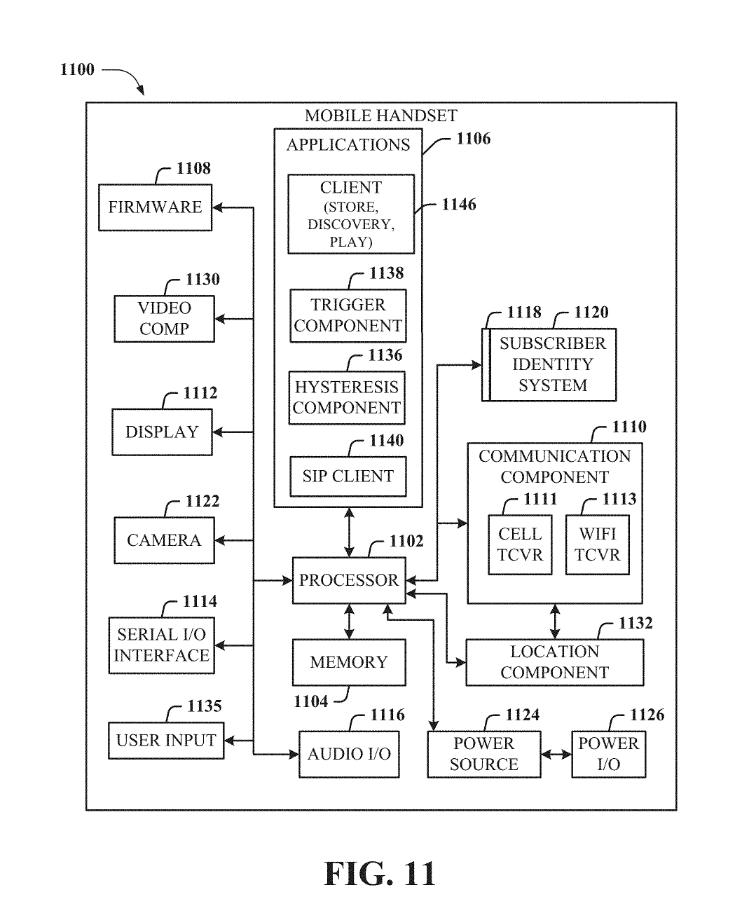

Referring now to FIG. 11, illustrated is a schematic block diagram of an exemplary end-user device such as a mobile device 1100 capable of connecting to a network in accordance with some embodiments described herein. Although a mobile handset 1100 is illustrated herein, it will be understood that other devices can be a mobile device, and that the mobile handset 1100 is merely illustrated to provide context for the embodiments of the various embodiments described herein. The following discussion is intended to provide a brief, general description of an example of a suitable environment 1100 in which the various embodiments can be implemented. While the description includes a general context of computer-executable instructions embodied on a machine-readable storage medium, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1100 includes a processor 1102 for controlling and processing all onboard operations and functions. A memory 1104 interfaces to the processor 1102 for storage of data and one or more applications 1106 (e.g., a video player software, user feedback component software, etc.). Other applications can include voice recognition of predetermined voice commands that facilitate initiation of the user feedback signals. The applications 1106 can be stored in the memory 1104 and/or in a firmware 1108, and executed by the processor 1102 from either or both the memory 1104 or/and the firmware 1108. The firmware 1108 can also store startup code for execution in initializing the handset 1100. A communications component 1110 interfaces to the processor 1102 to facilitate wired/wireless communication with external systems, e.g., cellular networks, VoIP networks, and so on. Here, the communications component 1110 can also include a suitable cellular transceiver 1111 (e.g., a GSM transceiver) and/or an unlicensed transceiver 1113 (e.g., Wi-Fi, WiMax) for corresponding signal communications. The handset 1100 can be a device such as a cellular telephone, a PDA with mobile communications capabilities, and messaging-centric devices. The communications component 1110 also facilitates communications reception from terrestrial radio networks (e.g., broadcast), digital satellite radio networks, and Internet-based radio services networks.

The handset 1100 includes a display 1112 for displaying text, images, video, telephony functions (e.g., a Caller ID function), setup functions, and for user input. For example, the display 1112 can also be referred to as a “screen” that can accommodate the presentation of multimedia content (e.g., music metadata, messages, wallpaper, graphics, etc.). The display 1112 can also display videos and can facilitate the generation, editing and sharing of video quotes. A serial I/O interface 1114 is provided in communication with the processor 1102 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1100, for example. Audio capabilities are provided with an audio I/O component 1116, which can include a speaker for the output of audio signals related to, for example, indication that the user pressed the proper key or key combination to initiate the user feedback signal. The audio I/O component 1116 also facilitates the input of audio signals through a microphone to record data and/or telephony voice data, and for inputting voice signals for telephone conversations.

The handset 1100 can include a slot interface 1118 for accommodating a SIC (Subscriber Identity Component) in the form factor of a card Subscriber Identity Module (SIM) or universal SIM 1120, and interfacing the SIM card 1120 with the processor 1102. However, it is to be appreciated that the SIM card 1120 can be manufactured into the handset 1100, and updated by downloading data and software.

The handset 1100 can process IP data traffic through the communication component 1110 to accommodate IP traffic from an IP network such as, for example, the Internet, a corporate intranet, a home network, a person area network, etc., through an ISP or broadband cable provider. Thus, VoIP traffic can be utilized by the handset 1100 and IP-based multimedia content can be received in either an encoded or decoded format.

A video processing component 1122 (e.g., a camera) can be provided for decoding encoded multimedia content. The video processing component 1122 can aid in facilitating the generation, editing and sharing of video quotes. The handset 1100 also includes a power source 1124 in the form of batteries and/or an AC power subsystem, which power source 1124 can interface to an external power system or charging equipment (not shown) by a power I/O component 1126.

The handset 1100 can also include a video component 1130 for processing video content received and, for recording and transmitting video content. For example, the video component 1130 can facilitate the generation, editing and sharing of video quotes. A location tracking component 1132 facilitates geographically locating the handset 1100. As described hereinabove, this can occur when the user initiates the feedback signal automatically or manually. A user input component 1134 facilitates the user initiating the quality feedback signal. The user input component 1134 can also facilitate the generation, editing and sharing of video quotes. The user input component 1134 can include such conventional input device technologies such as a keypad, keyboard, mouse, stylus pen, and/or touch screen, for example.

Referring again to the applications 1106, a hysteresis component 1136 facilitates the analysis and processing of hysteresis data, which is utilized to determine when to associate with the access point. A software trigger component 1138 can be provided that facilitates triggering of the hysteresis component 1138 when the Wi-Fi transceiver 1113 detects the beacon of the access point. A SIP client 1140 enables the handset 1100 to support SIP protocols and register the subscriber with the SIP registrar server. The applications 1106 can also include a client 1142 that provides at least the capability of discovery, play and store of multimedia content, for example, music.

The handset 1100, as indicated above related to the communications component 810, includes an indoor network radio transceiver 1113 (e.g., Wi-Fi transceiver). This function supports the indoor radio link, such as IEEE 802.11, for the dual-mode GSM handset 1100. The handset 1100 can accommodate at least satellite radio services through a handset that can combine wireless voice and digital radio chipsets into a single handheld device.

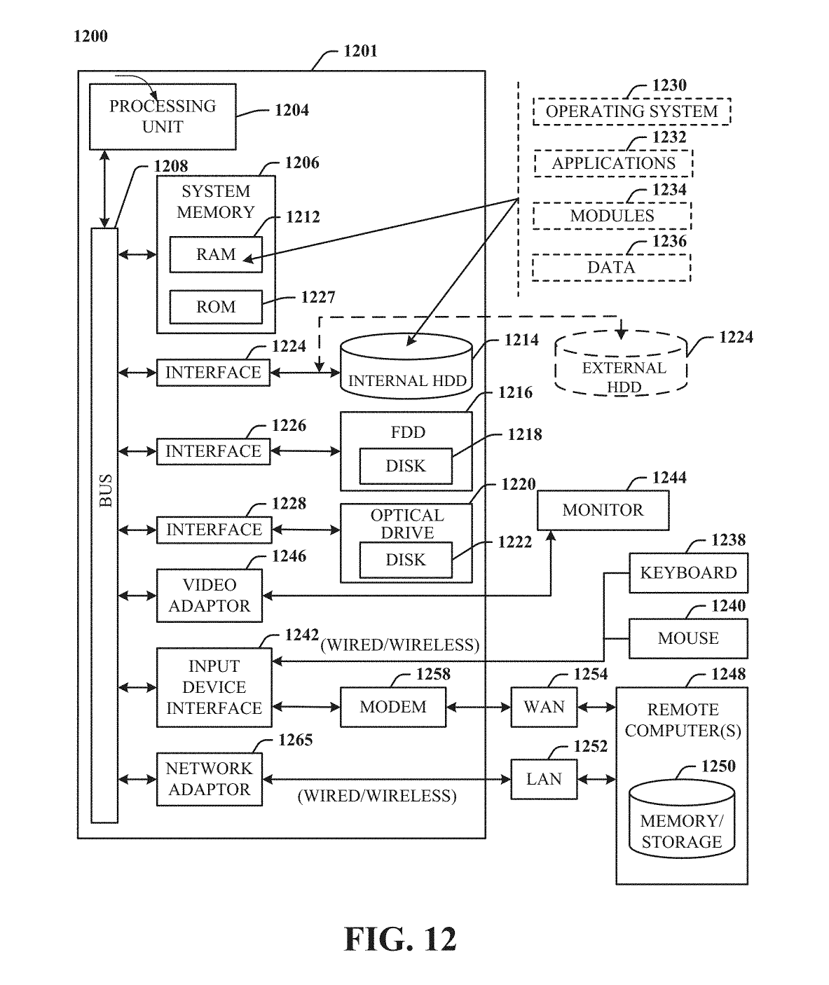

Referring now to FIG. 12, there is illustrated a block diagram of a computer 1200 operable to execute a system architecture that facilitates establishing a transaction between an entity and a third party. The computer 1200 can provide networking and communication capabilities between a wired or wireless communication network and a server and/or communication device. In order to provide additional context for various aspects thereof, FIG. 12 and the following discussion are intended to provide a brief, general description of a suitable computing environment in which the various aspects of the innovation can be implemented to facilitate the establishment of a transaction between an entity and a third party. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 12, implementing various aspects described herein with regards to the end-user device can include a computer 1200, the computer 1200 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes read-only memory (ROM) 1227 and random access memory (RAM) 1212. A basic input/output system (BIOS) is stored in a non-volatile memory 1227 such as ROM, EPROM, EEPROM, which BIOS contains the basic routines that help to transfer information between elements within the computer 1200, such as during start-up. The RAM 1212 can also include a high-speed RAM such as static RAM for caching data.

The computer 1200 further includes an internal hard disk drive (HDD) 1214 (e.g., EIDE, SATA), which internal hard disk drive 1214 can also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1294 interface technologies. Other external drive connection technologies are within contemplation of the subject innovation.

The drives and their associated computer-readable media provide nonvolatile storage of data, data structures, computer-executable instructions, and so forth. For the computer 1200 the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer 1200, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that the innovation can be implemented with various commercially available operating systems or combinations of operating systems.

A user can enter commands and information into the computer 1200 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 2394 serial port, a game port, a USB port, an IR interface, etc.

A monitor 1244 or other type of display device is also connected to the system bus 1208 through an interface, such as a video adapter 1246. In addition to the monitor 1244, a computer 1200 typically includes other peripheral output devices (not shown), such as speakers, printers, etc.

The computer 1200 can operate in a networked environment using logical connections by wired and/or wireless communications to one or more remote computers, such as a remote computer(s) 1248. The remote computer(s) 1248 can be a workstation, a server computer, a router, a personal computer, portable computer, microprocessor-based entertainment device, a peer device or other common network node, and typically includes many or all of the elements described relative to the computer, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1200 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1200 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 through the input device interface 1242. In a networked environment, program modules depicted relative to the computer, or portions thereof, can be stored in the remote memory/storage device 1250. It will be appreciated that the network connections shown are exemplary and other means of establishing a communications link between the computers can be used.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
demarcating, by a wireless network device comprising a processor, a physical location for an augmented reality function;
receiving, by the wireless network device, request data indicative of a request to reserve the physical location from a mobile device;
in response to the receiving the request data and based on a condition associated with the augmented reality function being determined to have been satisfied, allocating, by the wireless network device, the physical location for usage according to the augmented reality function; and
based on the allocating, receiving, by the wireless network device from the mobile device, service data representative of a service related to the augmented reality function.

2. The method of claim 1, further comprising:
mapping, by the wireless network device, the physical location into three dimensions, resulting in three dimensional data representative of a three dimensional space associated with the physical location.

3. The method of claim 2, wherein the augmented reality function comprises a holographic projection.

4. The method of claim 1, further comprising:
in response to the receiving, generating, by the wireless network device, fee data representative of a fee associated with the service related to the augmented reality function.

5. The method of claim 4, further comprising:
sending, by the wireless network device, the fee data to the mobile device.

6. The method of claim 5, further comprising:
in response to sending the fee data, receiving, by the wireless network device, transaction data indicative of the fee being determined to have been paid.

7. The method of claim 6, wherein the service comprises an interactive gaming service.

8. A system, comprising:
a processor; and
a memory that stores executable instructions that, when executed by the processor, facilitate performance of operations, comprising:
mapping three dimensional location data representative of a three dimensional space to a physical location, resulting in mapped location data;
receiving request data associated with a request to assign the mapped location data to a user identity;
in response to receiving the request data, allocating the mapped location data to the user identity, resulting in location allocation data that identifies the user identity as having an access privilege with respect to the mapped location data; and
facilitating an augmented reality service at the physical location according to the three dimensional space.

9. The system of claim 8, wherein the augmented reality service comprises an advertising data service associated with managing of rendering of advertisement data representative of an advertisement from the user identity.

10. The system of claim 9, wherein the operations further comprise:
based on the advertising data service, sending the advertisement data to a mobile device.

11. The system of claim 8, wherein the request data comprises time data associated with a requested time for the facilitating of the augmented reality service.

12. The system of claim 11, wherein the operations further comprise:
in response to a condition associated with the allocating being determined to have been satisfied, delaying the allocating the mapped location data.

13. The system of claim 12, wherein the user identity is a first user identity, and wherein the condition is related to reserving the mapped location data at the requested time for a second user identity.

14. The system of claim 8, wherein the operations further comprise:
in response to the allocating the mapped location data, sending confirmation data, representative of a confirmation, to the user identity.

15. A machine-readable storage medium, comprising executable instructions that, when executed by a processor, facilitate performance of operations, comprising:
receiving a request for an augmented reality location associated with a physical location;
in response to the receiving the request, analyzing payment data representative of a payment from a mobile device;
in response to a condition associated with the payment data being determined to have been satisfied, reserving the augmented reality location for a user identity associated with the mobile device; and
based on the reserving, facilitating displaying an augmented reality projection associated with the request for the user identity.

16. The machine-readable storage medium of claim 15, wherein the request is a first request, and wherein the first request comprises a second request to display an advertisement associated with the user identity, resulting in an advertisement display for the augmented reality location associated with the physical location.

17. The machine-readable storage medium of claim 16, wherein the condition is a first condition, and wherein the operations further comprise:
in response to a second condition associated with time being determined to have been satisfied, terminating the advertisement display.

18. The machine-readable storage medium of claim 16, wherein the advertisement display comprises a holographic display.

19. The machine-readable storage medium of claim 18, wherein the holographic display is an interactive holographic display.

20. The machine-readable storage medium of claim 18, wherein the holographic display is responsive to human interaction determined to have been received by the user identity.
